(19) United States
(12) Patent Application Publication
(10) Pub. No.: US 2005/0050130 A1
(43) Pub. Date: Mar. 3, 2005

(54) Ranging in multi-band OFDM communications systems

(76) Inventors: Anand G. Dabak, Plano, TX (US); Anuj Batra, Dallas, TX (US); Jaiganesh Balakrishnan, Dallas, TX (US)

Correspondence Address: TEXAS INSTRUMENTS INCORPORATED, P O BOX 655474, M/S 3999, DALLAS, TX, 75265, US

(21) Appl. No.: 10/932,894

(22) Filed: Sep. 2, 2004

Related U.S. Application Data
(60) Provisional application No. 60/499,579, filed on Sep. 2, 2003.

(51) Int. Cl. G06F 17/15

(52) U.S. Cl. 708/426

(57) ABSTRACT

System and method for determining a separation between communicating devices. A preferred embodiment comprises a first device transmitting a signal over multiple subbands to a second device, the second device determining a timing for the signal by processing the signal in each subband separately. The second device then transmits a signal back to the first device along with timing information (again, over multiple subbands). The first device then determines a timing for the signal and by determining a difference in the timing information provided by the second device and timing information it determines, the first device can compute the separation between it and the second device. The use of multiple subbands can dedicate more bandwidth to the transmission of the signal, permitting greater resolution.

### CROSS-REFERENCE TO RELATED APPLICATIONS

This application claims the benefit of U.S. Provisional Application No. 60/499,579, filed Sep. 2, 2003, entitled “Ranging for Multi-Band OFDM UWB System,” which application is hereby incorporated herein by reference.

### TECHNICAL FIELD

The present invention relates generally to a system and method for digital wireless communications, and more particularly to a system and method for determining a separation between communicating devices.

### BACKGROUND

Ranging, or determining a distance between two communicating devices in a wireless communications network, can have many important applications in today's world. For example, when a person with a cellular telephone walks within a certain distance from a store, the store can put an advertisement onto the screen of the cellular telephone, or when the owner of an automobile walks to within a few feet of his car, the doors automatically unlock. Another use of ranging may be in home theater systems, wherein ranging can be used to automatically determine distances from a home theater receiver and various speakers in the theater setup. This can then be used to adjust delays inserted into audio channels to help optimize sound quality. Ranging can also be used to enable special operating modes. For example, when two communicating devices in a wireless communications network are less than a certain distance apart, they may enable a special higher data rate operating mode that may operate reliably when they are close to one another.

In a wireless communications system, the resolution (precision) of the ranging can be dependent upon the bandwidth of the signal being used to perform the ranging, with larger bandwidth signals typically providing a higher resolution result. It can be preferred that a signal with good time auto-correlation properties be used for ranging.

A commonly used technique to perform ranging is for one device (first device) to transmit a special signal to another device (second device). The second device could then measure a timing of the received signal. The second device can then send this timing back to the first device along with a special signal, wherein the special signal sent by the second device is usually the same as the special signal sent by the first device, although they do not have to be the same. The first device can then measure a timing of the received signal and use it to calculate the separation between the second device and the first device.

One disadvantage of the prior art is that for a multi-band communications system, the special signal used in ranging will typically be limited to the bandwidth of a single transmission band (or equivalently, subband). Therefore, the bandwidth of the special signal may not be as large as necessary to provide the desired resolution.

### SUMMARY OF THE INVENTION

These and other problems are generally solved or circumvented, and technical advantages are generally achieved, by preferred embodiments of the present invention which provides a system and method for determining a separation between communicating devices.

In accordance with a preferred embodiment of the present invention, a method for determining a separation between a first device and a second device is provided. The method comprises transmitting a first signal on a first plurality of subbands to the second device, wherein the first signal is known at the second device and receiving a second signal from the second device, wherein a second plurality of subbands is used to transmit the second signal, wherein the second signal is known at the first device. A timing for the second signal can then be determined and the separation can be calculated based upon the timing for the second signal.

In accordance with another preferred embodiment of the present invention, a circuit comprising a plurality of correlating branches coupled to a signal input and a combiner coupled to the plurality of correlating branches is provided. Wherein each correlating branch is configured to correlate a received signal with a hypothesis, wherein the received signal provided to a processing branch is from a subband in a transmitted signal, and wherein each subband carries a known signal. The combiner is configured to combine the outputs from the plurality of correlating branches.

An advantage of a preferred embodiment of the present invention is that in a multi-band communications system, multiple transmission bands (or equivalently, subband) can be used in the ranging operation. The use of multiple subbands can increase the effective bandwidth of the signal used, thereby increasing the resolution (precision) of the ranging measurement.

A further advantage of a preferred embodiment of the present invention is that there is no fixed number of subbands that can be used in the ranging operation. Therefore, when there are many subbands available for use, then a large number of subbands can be used. When a small number of subbands are available, then only a few subbands can be used.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a diagram of two communicating devices in a wireless communications network;

FIG. 2 is a diagram of a frequency allocation map for a wireless communications system;

FIG. 3 is a diagram of a ranging operation between a source device and a destination device;

FIG. 4 is a diagram of a ranging operation between a source device and a destination device, wherein the ranging operation can take advantage of multiple subbands, according to a preferred embodiment of the present invention;

FIG. 5 is a diagram illustrating the determination of the timing for a received signal;

FIGS. 6a and 6b are diagrams illustrating algorithms for ranging operations at a source device and a destination device, using multiple subbands to increase available bandwidth, according to a preferred embodiment of the present invention;

FIG. 7 is a diagram of an algorithm for processing correlator outputs, wherein the correlator outputs can be precombined, according to a preferred embodiment of the present invention;

FIG. 8 is a diagram of an algorithm for processing correlator outputs, wherein the correlator outputs can be postcombined, according to a preferred embodiment of the present invention;

FIG. 9 is a diagram of an algorithm for processing correlator outputs, wherein the correlator outputs can be coherently combined, according to a preferred embodiment of the present invention; and

FIGS. 10a through 10c are diagrams of circuits for use in a ranging operation, wherein the circuit makes use of precombining of correlator outputs, postcombining of correlator outputs, and coherent combining, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a multi-band orthogonal frequency division multiplexed (OFDM) wireless communications system using the ultra-wideband (UWB) spectrum. The UWB spectrum in the United States is specified in a Report and Order issued by the Federal Communications Commission (FCC) entitled “FCC 02-48—In the matter of Revision of Part 15 of the Commission's Rules Regarding Ultra-Wideband Transmission Systems,” published Apr. 22, 2002. The invention may also be applied, however, to other communications systems that make use of multiple transmission bands, such as those employing frequency hopping spread spectrum modulation.

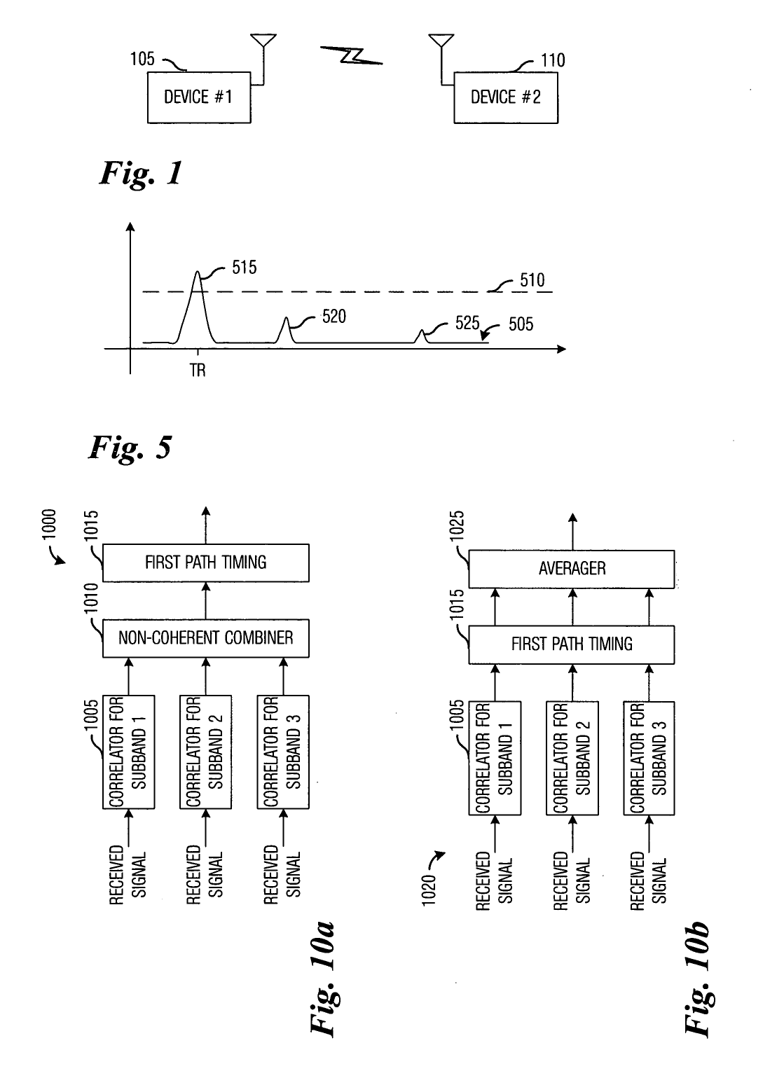

With reference now to FIG. 1, there is shown a diagram illustrating two communicating devices that make up part of a wireless communications system. A first device, device #1, 105 and a second device, device #2, 110 can be communicating with one another. During operations, device #1 105 (for example) may want to determine the separation between itself and device #2, 110 to perhaps change operating modes, for example. According to a prior art technique, the device #1 105 would then transmit a special signal to the device #2 110. The device #2 110 could, upon receipt of the special signal, use a correlator to find a first path of the special signal from the device #1 105 to the device #2 110. The first path of the special signal can be defined as the first path that exceeds a prespecified threshold. Note that a correlator is a low-complexity channel estimator and that other channel estimators can be used to find the first path. Examples of other channel estimators can include those that make use of least-squares estimation and training-based adaptive channel identification techniques. Therefore, the use of a correlator should not be construed as being limiting to the spirit of the present invention.

For discussion purposes, let the device #1 105 transmit a special signal S to the device #2 110 at time T^{1t} on subband B1, wherein “1t” can represent transmit time at the device #1 105. The device #2 110 can receive the special signal S and use a correlator to determine the arrival of the first path from the device #1 105 to the device #2 110. Let the correlator output for subband B1 be denoted as {d₁¹,d₂¹, . . . , d_{N}¹} at the receiver of the device #2 110, wherein d_{K}¹ is the K-th path in subband B1.

The device #2 110 can then select a path from the output of the correlator that is the first that exceeds the prespecified threshold. To simplify timing, it is assumed that a clock can be initialized at the beginning of correlator operation for the subband B1 and a time associated with the selected path is denoted T^{2r}, wherein “2r” can represent the receive time at the device #2 110. The device #2 110 can then transmit the special sequence back to the device #1 105, at time T^{2t}, for example. The device #1 105 can also determine the first path from this transmission using its own correlator, whose associated receive time can be denoted T^{1r}. A difference in the time of transmission of the special sequence, S, from the device #1 105 to the device #2 110 and the arrival of the special sequence, S, back at the device #1 105 minus the processing time at the device #2 110 can be given by the expression:
δ(subband D1)=T^{1t}−T^{1r}−(T^{2t}−T^{2r})
and can be used to calculate the separation between the device #1 105 and the device #2 110.

The prior art technique can be used in a single band communications system or in a multi-band communications system. In either case, the special signal S should occupy as much bandwidth as possible since the resolution of the ranging operation can be dependent upon the bandwidth of the special signal S. Note that in a multi-band communications system, the prior art technique would use a single subband, which can limit the bandwidth being used. Even if additional bandwidth were available, the prior art technique would not take advantage.

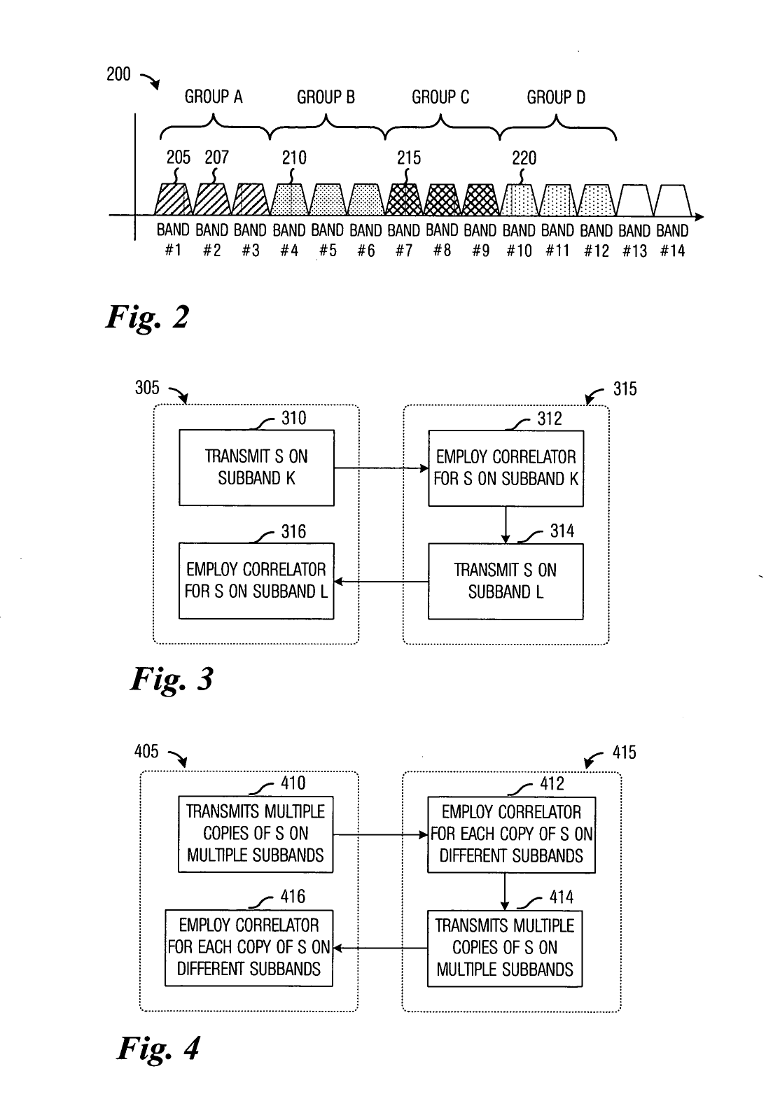

With reference now to FIG. 2, there is shown a diagram illustrating a frequency allocation map 200 for a wireless communications system. The frequency allocation map 200 may be for a multi-band OFDM wireless communications system, such as one that is adherent to IEEE 802.15.3a technical requirements, which are specified in a document entitled “IEEE 802.15 Working Group for Wireless Personal Area Networks (WPANs)—TG3a Technical Requirements,” published December 2002. The frequency allocation map 200 shows that the wireless communications system has fourteen (14) subbands grouped into four groups, a first group “group A” containing three subbands, such as subband #1 205 and subband #2 207, a second group “group B” containing three subbands, such as subband #4 210, a third group “group C” containing three subbands, such as subband #7 215, and a fourth group “group D” containing three subbands, such as subband #10 220. Note that the number of subbands in a group and the total number of groups may be arbitrary and may be changed.

With reference now to FIG. 3, there is shown a diagram illustrating a ranging operation between a source device 305 and a destination device 315. FIG. 3 can be used to display a flow of signals and information between the source device 305 and the destination device 315. The ranging operation can begin with the source device 305 transmitting to the destination device 315 a special signal S on a subband K (block 310). Note that if the source device 305 and the destination device 315 are part of a communications system that does not use subbands, then the special signal S can be transmitted on all of the available bandwidth. The destination device 315, upon receiving the special signal S can employ a correlator to correlate the received signal from the subband K (block 320). The correlator can be used to determine timing for the special signal S and any reflected copies of S present in the received signal. As discussed previously, a correlator is a low-complexity channel estimator and other channel estimators can be used to find the first path. Examples of other channel estimators can include those that make use of least-squares estimation and training-based adaptive channel identification techniques. Therefore, the use of a correlator should not be construed as being limiting to the spirit of the present invention.

After determining the timing for the special signal S the destination device 315 can transmit the special signal S back to the source device 305 using subband L, wherein subband L may be the same subband as subband K or different (block 314). In addition to the special signal S the destination device 315 may also transmit the timing for the special signal S to the source device 305. At the source device 305, the source device 305 can employ a correlator to correlate the received signal from the subband L (block 316). The correlation at the source device 305 can determine timing for the special signal S and any reflected copies of S that may be present in the received signal, similar to block 312. From the timing determined in block 316 and received from the destination device 315, the source device 305 can calculate the separation between itself and the destination device 315.

With reference now to FIG. 4, there is shown a diagram illustrating a ranging operation between a source device 405 and a destination device 415, wherein the ranging operation can take advantage of multiple subbands, according to a preferred embodiment of the present invention. As described in FIG. 3, whenever a ranging operation is to be performed, a special signal S can be transmitted between devices and the separation between the two devices can be computed based upon timings of the special signal S. However, the resolution of the ranging operation can be dependent upon the bandwidth of the special signal S wherein greater resolution can be achieved when more bandwidth is dedicated to the special signal. Unfortunately, in a multi-band communications system, the subbands are often fixed in bandwidth and cannot be readily changed. Therefore, the bandwidth allocated for the special signal S cannot be changed.

However, it can be possible to transmit the special signal S over multiple subbands and use processing techniques at the receive end to effectively increase the bandwidth dedicated to the special signal S. According to a preferred embodiment of the present invention, rather than having the source device 405 transmit the special signal S on a single subband, multiple copies of the special signal S can be transmitted on different subbands (block 410). Note however, that it may be possible to transmit a different special signal on each subband, as long as the signals being transmitted are known at the destination device 415. For example, if three subbands are being used, then the source device 405, then the source device 405 can transmit signal S1 on subband #1, signal S2 on subband #2, and signal S3 on subband #3, wherein signals S1, S2, and S3 are different. At the destination device 415, multiple correlators (or other channel estimators) can be used to correlate the received signal on each of the subbands (block 412). Processing of the correlator outputs can combine the correlator outputs so that the effective bandwidth of the special signal S can be increased. Detailed discussion of the processing of the correlator outputs is provided below.

After determining the timing for the special signal S the destination device 415 can transmit multiple copies of the special signal S back to the source device 405 using multiple subbands (block 414). Once again, multiple correlators can be used to determine a timing for the special signal S in the received signal (block 416). Note that it can be possible to vary the number of subbands used to carry the special signal S. For example, in one stage (such as when transmitting from the source device 405 to the destination device 415) of the ranging operation, a single subband can be used to transmit the special signal S while in the other stage (such as when transmitting from the destination device 415 to the source device 405), multiple subbands can be used to transmit the special signal S. Alternatively, in one stage, three subbands can be used to transmit while in the other stage, two subbands can be used to transmit.

With reference now to FIG. 5, there is shown a diagram illustrating the determination of the timing for a received signal. Correlators (or other channel estimators) can be used to determine the timing of a received signal carrying the special signal S. A correlator can test a specific hypothesis (a guess of the timing) by comparing the received signal with a version of the signal being tested that has been adjusted based upon the guess of the timing. If there is a good match between the received signal and the hypothesis, then the correlator can produce a large valued output. FIG. 5 displays an output of a correlator as a trace 505 as a function of hypothesis (the x-axis). A dashed horizontal line 510 can represent a threshold above which a hypothesis can be considered good.

The trace 505 shows three spikes 515, 520, and 525. These three spikes can correspond to different hypotheses that resulted in at least a partial match between the received signal and the various hypotheses. Note that the spike 515 has a magnitude that exceeds the threshold displayed as the dashed line 510. This can mean that the hypothesis corresponding to the spike 515 can be a good hypothesis. This hypothesis is shown in FIG. 5 as “TR.” This can perhaps relate to the main path taken by the special signal S from a source device to a destination device. Note that the remaining two spikes 520 and 525 do not have magnitudes exceeding the threshold and therefore can be ignored. The time “TR” can then be the timing of the special signal S and can be used in the determination of the separation between the source and the destination devices.

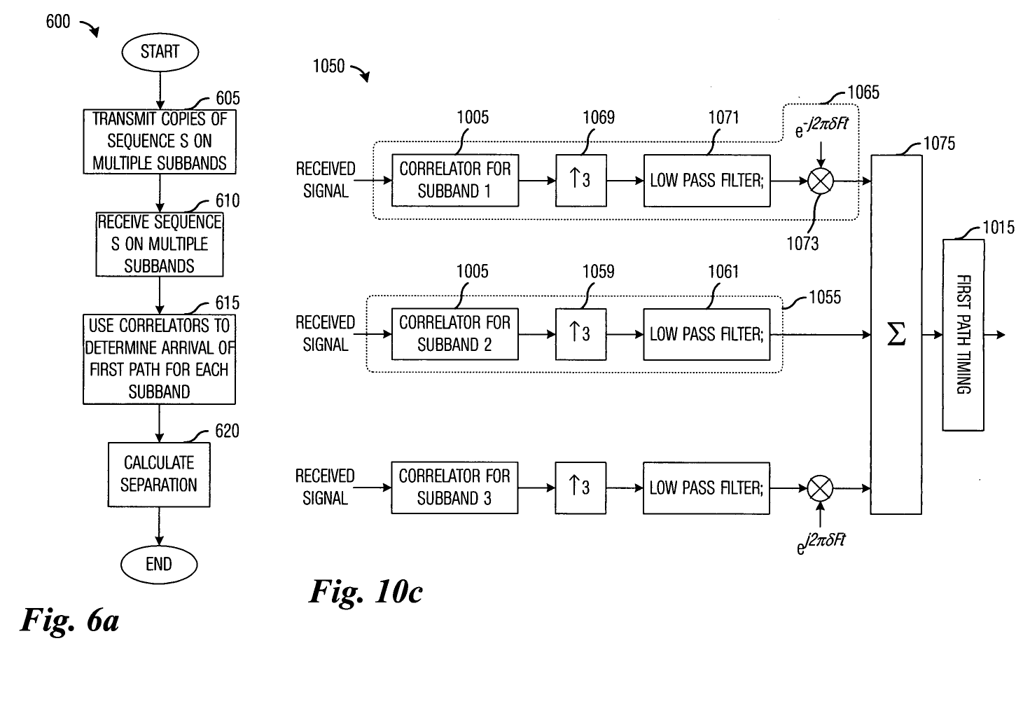

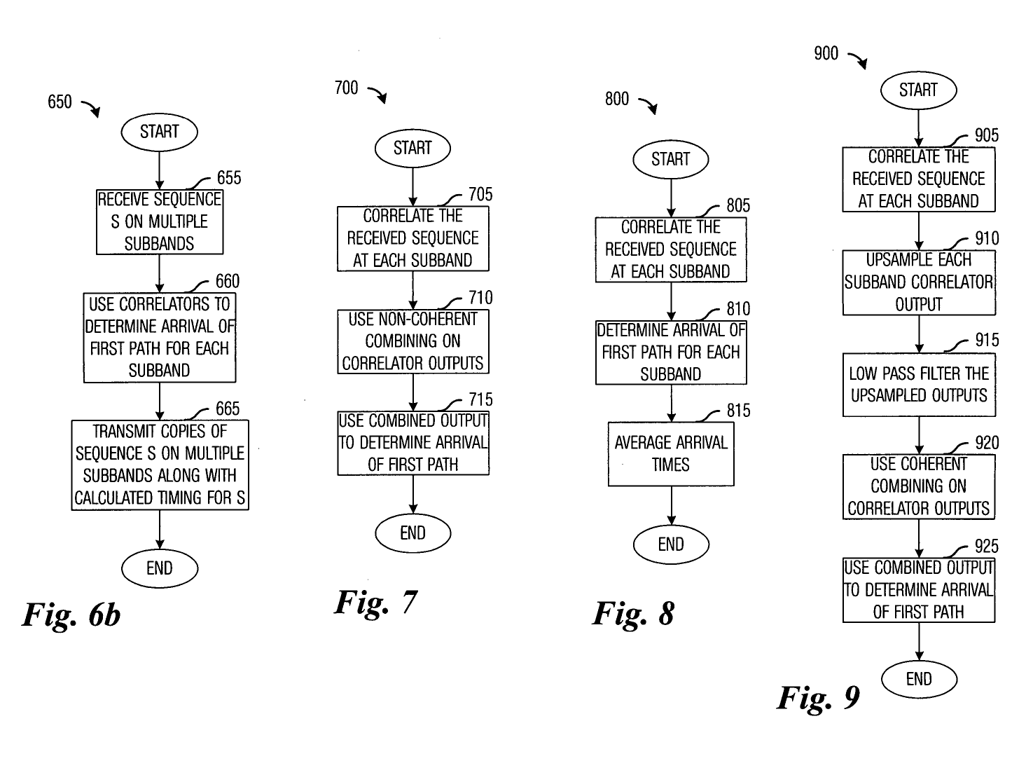

With reference now to FIGS. 6a and 6b, there are shown flow diagrams illustrating algorithms for a ranging operation at a source device (algorithm 600) and at a destination device (algorithm 650) wherein multiple subbands can be used to increase the bandwidth used for the transmission of the special signal S, according to a preferred embodiment of the present invention. According to a preferred embodiment of the present invention, the algorithms 600 and 650 may execute on controllers (or general purpose processing elements, special purpose processing elements, custom designed integrated circuits, or so forth) located in the source device and the destination device respectively. When the source device desires to perform a ranging operation, its controller can begin to execute the algorithm 600, while at the destination device, the destination device's controller can begin to execute the algorithm 650 after it is told to enter ranging mode, perhaps via a control message sent by the source device.

At the source device, the ranging operation can begin when the source device transmits multiple copies of the special signal S on a plurality of subbands (block 605). Note that it may also be possible to sent a different signal on each of the plurality of subbands, rather than sending copies of a single signal (the special signal S) on each subband. In any case, the signal(s) being transmitted should be known at the destination device. The source device can store a time that corresponds to when it transmits the special signal S to the destination device, denoted T^{1t}. According to a preferred embodiment of the present invention, there may not be an upper limit upon the number of subbands used by the source device other than a physical limit due to the total number of subbands available in the communications system. After transmitting the multiple copies of the special signals, S, the source device can be idle until it receives a transmission of multiple copies of the special signals, S, on a plurality of subbands from the destination device (block 610).

After receiving a received signal made up of multiple copies of the special signal S the source device can use a plurality of correlators to determine a timing for each copy of the special signal S in each subband (block 615). Since there are multiple subbands, there may be multiple different special signals, S, for each subband that may need to be combined. The combined timing can be denoted T^{1r}. According to a preferred embodiment of the present invention, there should be a correlator for each subband. However, it can be possible to buffer the received signal so that a smaller number of correlators can be used for a larger number of subbands. Several different techniques can be used to determine the timing for each copy of the special signal S and for combining the different timings. A discussion of these techniques can be found below.

After determining the timing of the special signal S as transmitted by the destination device, the source device can calculate the separation between it and the destination device (block 620). In addition to transmitting multiple copies of the special signal S the destination device can also transmit to the source device a time corresponding to a receive time of the transmission of the special signal S from the source device to the destination device, denoted T^{2r}. The destination device can also transmit to the source device a time corresponding to a time when the destination device transmits the special signal S to the source device, denoted T^{2t}. The separation between the source device and the destination device can be determined from a difference in the time of the transmission of the special signal S from the source device to the destination device and the arrival of the special signal S back from the destination device minus a processing time at the destination device. This difference can be expressed as:
δ(special signal)=T^{1t}−T^{1r}−(T^{2t}−T^{2r}).

At the destination device, the controller can begin executing the algorithm 650 after it receives a message from the source device to enter ranging mode. Once the destination device enters ranging mode, it can wait to receive a signal containing multiple copies of the special signal S on a plurality of subbands (block 655). The destination device can use a plurality of correlators to determine a timing for each copy of the special signal S in each subband (block 660). Since there are multiple subbands, there may be multiple different copies of the special signal S for each subband that may need to be combined. The combined timing can be denoted T^{2r}. As in the case of the source device, there should be a correlator for each subband. However, it can be possible to buffer the received signal so that a smaller number of correlators can be used for a larger number of subbands. Several different techniques can be used to determine the timing for each copy of the special signal S and for combining the different timings. A discussion of these techniques can be found below.

After determining the timing for the special signal S the destination device can transmit back to the source device multiple copies of the special signal S on a plurality of subbands (block 665). Note that the number of subbands used by the destination device may not have to be equal to the number of subbands used by the source device. In addition to transmitting the special signal S back to the source device, the destination device can transmit the timing information, T^{2r}. Furthermore, the destination device can transmit timing information regarding the transmission of the special signal S to the source device, namely a time corresponding to the time when the transmission was initiated, denoted, T^{2t}. After transmitting the multiple copies of the special signal S to the source device, the controller of the destination device can terminate the execution of the algorithm 650.

With reference now to FIG. 7, there is shown a flow diagram illustrating an algorithm 700 for processing correlator outputs, wherein the correlator outputs can be precombined, according to a preferred embodiment of the present invention. The algorithm 700 can be used in the processing of correlator outputs as a result of the correlation of a received signal containing multiple copies of the special signal S, wherein each copy of the special signal S is carried on a different subband. The algorithm 700 can be an embodiment of a technique used to determine the timing for each copy of the special signal S and for combining the different timings into a combined timing, such as block 615 of FIG. 6a and block 660 of FIG. 6b.

For discussion purposes, let the number of subbands used to carry the special signal S be three. Note that there may not be a limit on the number of subbands used other than a physical limit due to the total number of subbands available in the communications system and a practical limit due to the number of subbands that are not in use. The processing of the received signal can begin with each correlator correlating for the special signal S in a single subband (block 705). For example, if there are three subbands, then a correlator can be assigned to correlate for the special signal in one of the three subbands. Note that for optimal performance, three correlators should be used. However, the received signal can be buffered and a single correlator can be used to perform the correlations for the three subbands. Let the correlator output for subband K be denoted {d₁^{K},d₂^{K}, . . . , d_{N}^{K}}. Therefore, the correlator output for subband one (1) could be denoted {d₁¹,d₂¹, . . . , d_{N}¹}.

According to a preferred embodiment of the present invention, the outputs of the different correlators can be combined in a non-coherent fashion (block 710). Non-coherent combining is considered to be well understood by those of ordinary skill in the art of the present invention and will not be discussed herein. For example, if the combined correlator output can be denoted as {\tilde{d}₁, \tilde{d}₂, . . . , \tilde{d}_{N}}, then the combined correlator output can be expressed mathematically as:
{\tilde{d}₁, \tilde{d}₂, . . . , \tilde{d}_{N}}={\sqrt{(d₁¹)²+(d₁²)²+(d₁³)²}, \sqrt{(d₂¹)²+(d₂²)²+(d₂³)²}, . . . , \sqrt{(d_{N}¹)²+(d_{N}²)²+(d_{N}³)²}}.

After non-coherent combining, the combined correlator output can be processed to determine the timing of special signal S (block 715). This can involve parsing the combined correlator output to find a first peak that exceeds a pre-specified threshold (refer to the discussion of FIG. 5 for a detailed explanation). The first peak that exceeds the pre-specified threshold can be considered to be a main path of the special signal S. In other words, the main path is considered to be the line-of-sight path between the transmitter of the special signal S and the receiver of the special signal S. Subsequent peaks are considered to be reflected paths since the reflected paths will have to travel a longer distance, they will arrive at the receiver at a later time. A time associated with the first peak can then be considered to be the timing of the special signal S.

With reference now to FIG. 8, there is shown a flow diagram illustrating an algorithm 800 for processing correlator outputs, wherein the correlator outputs can be postcombined, according to a preferred embodiment of the present invention. The algorithm 800 can be used in the processing of correlator outputs as a result of the correlation of a received signal containing multiple copies of the special signal S, wherein each copy of the special signal S is carried on a different subband. The algorithm 800 can be an embodiment of a technique used to determine the timing for each copy of the special signal S and for combining the different timings into a combined timing, such as block 615 of FIG. 6a and block 660 of FIG. 6b.

Again, for discussion purposes, let the number of subbands used to carry the special signal S be three. The processing of the received signal can begin with each correlator correlating for the special signal S in a single subband (block 805). Let the correlator output for subband K be denoted {d₁^{K},d₂^{K}, . . . , d_{N}^{K}}. The output of each correlator can then be processed to determine the timing of the special signal S (block 810). As discussed above, the processing can be used to determine the timing of a first peak in each correlator output that exceeds a pre-specified threshold. According to a preferred embodiment of the present invention, the pre-specified threshold is the same for each correlator output. Alternatively, the pre-specified threshold can vary for different correlator output. With the timing for each subband determined (block 810), an average timing can be computed (block 815). The timing can be computed via a simple averaging of the three individual timings. Alternatively, a weighted average of the three timings can be computed. The weighting can be based on an importance placed upon certain subbands, for example.

With reference now to FIG. 9, there is shown a flow diagram illustrating an algorithm 900 for processing correlator outputs, wherein the correlator outputs can be coherently combined, according to a preferred embodiment of the present invention. The algorithm 900 can be used in the processing of correlator outputs as a result of the correlation of a received signal containing multiple copies of the special signal S, wherein each copy of the special signal S is carried on a different subband. The algorithm 900 can be an embodiment of a technique used to determine the timing for each copy of the special signal S and for combining the different timings into a combined timing, such as block 615 of FIG. 6a and block 660 of FIG. 6b.

Once again, for discussion purposes, let the number of subbands used to carry the special signal S be three. Without loss of generality, assume that subband two (2) is centered at carrier frequency Fc, while subband one (1) is centered at frequency Fc−δF and subband three (3) is centered at frequency Fc+δF. Note that the number of subbands do not need to be odd (i.e., they do not need to be symmetric about a central subband). The processing of the received signal can begin with each correlator correlating for the special signal S in a single subband (block 905). Let the correlator output for subband K be denoted {d₁^{K},d₂^{K}, . . . , d_{N}^{K}}. The output of each correlator can then be upsampled (block 910). For the three subband case, the output of each correlator should be upsampled by a factor of three. In general, when the number of subbands is N, then the upsampling factor should also be by a factor of N. After upsampling, each correlator's output can then be passed through a low pass filter (block 915). The low pass filtering and the upsampling can effectively interpolate the correlator output. After filtering and upsampling (interpolation), the correlator outputs can be coherently combined (block 920). Coherent combination is considered to be well understood by those of ordinary skill in the art of the present invention and will not be discussed herein. After coherent combining, the combined output can be processed to determine the timing of the special signal S (block 925).

With reference now to FIG. 10a, there is shown a diagram illustrating a circuit 1000 for use in a ranging operation, wherein the circuit 1000 makes use of precombining of correlator outputs, according to a preferred embodiment of the present invention. For discussion purposes, let the number of subbands used to carry the special signal S be three. Without loss of generality, assume that subband two (2) is centered at carrier frequency Fc, while subband one (1) is centered at frequency Fc−δF and subband three (3) is centered at frequency Fc+δF. Note however, that the number of subbands need not be three and that symmetry about a subband need not be maintained.

The circuit 1000 can have a correlator (such as correlator 1005) for each of the three subbands, with the output of the three correlators being provided to a non-coherent combiner 1010. Note that each of the three correlators is a channel estimator and that other channel estimators can be used in its place. It may be possible to improve the accuracy of a timing estimate provided by the correlator by correlating a received signal on the subbands with an inverse of the special signal S. The non-coherent combiner 1010 can combine the outputs of the three correlators to produce a signal that can be expressed as:
{\tilde{d}₁, \tilde{d}₂, . . . , \tilde{d}_{N}}={\sqrt{(d₁¹)²+(d₁²)²+(d₁³)²}, \sqrt{(d₂¹)²+(d₂²)²+(d₂³)²}, . . . , \sqrt{(d_{N}¹)²+(d_{N}²)²+(d_{N}³)²}},
wherein {\tilde{d}₁, \tilde{d}₂, . . . , \tilde{d}ₙ} is the output of the non-coherent combiner 1010. The output of the non-coherent combiner 1010 can then be provided to a first path timing unit 1015, wherein the timing of a first path from the output of the non-coherent combiner 1010 that exceeds a certain threshold can be determined. Refer to the discussion of FIG. 5 for a detailed description of the operation of the first path timing unit 1015.

With reference now to FIG. 10b, there is shown a diagram illustrating a circuit 1020 for use in a ranging operation, wherein the circuit 1020 makes use of postcombining of correlator outputs, according to a preferred embodiment of the present invention. For discussion purposes, let the number of subbands used to carry the special signal S be three. Without loss of generality, assume that subband two (2) is centered at carrier frequency Fc, while subband one (1) is centered at frequency Fc−δF and subband three (3) is centered at frequency Fc+δF. Note however, that the number of subbands need not be three and that symmetry about a subband need not be maintained.

The circuit 1020 can have a correlator (such as correlator 1005) for each of the three subbands, with the output of the three correlators being provided to the first path timing unit 1015. Rather than producing timing information for a single first path, in this configuration, the first path timing unit 1015 produces timing information for a first path for each of the three correlator inputs. The timing information can then be provided to an averager 1025 wherein the timing information can be averaged together. According to a preferred embodiment of the present invention, simple averaging can be performed by the averager 1025. However, the averager 1025 can perform a weighted averaging to combine the timing information.

With reference now to FIG. 10c, there is shown a diagram illustrating a circuit 1050 for use in a ranging operation, wherein the circuit 1050 makes use of coherent combining, according to a preferred embodiment of the present invention. For discussion purposes, let the number of subbands used to carry the special signal S be three. Without loss of generality, assume that subband two (2) is centered at carrier frequency Fc, while subband one (1) is centered at frequency Fc−δF and subband three (3) is centered at frequency Fc+δF. Note however, that the number of subbands need not be three and that symmetry about a subband need not be maintained.

In order to process the received signal in each of the subbands, the circuit 1050 can feature a processing branch for each subband. For example, processing branch 1055 may be used to process the received signal for subband two (2), which is centered at carrier frequency Fc and processing branch 1065 may be used to processing the received signal for subband one (1), which is centered at frequency Fc−δF. Note that a processing branch for other subbands (subband three (3) in this example) may have a similar appearance to the processing branch 1065 but with a different mixing frequency.

The processing branch 1055 can include the correlator 1005, an upsampler 1059, and a low pass filter 1061. The correlator 1005 can be used to test the received signal (within a particular subband) with multiple hypotheses and to produce a correlation result for each hypothesis. The upsampler 1059 can be used to add additional samples to the output of the correlator 1005. According to a preferred embodiment of the present invention, with three subbands, the upsampler 1059 could upsample the output of the correlator 1005 by a factor of three (3). The low pass filter 1061 can be used to remove undesired images of the output of the correlator 1005 that may have been a result of the upsampling (by the upsampler 1059). The combination of the upsampler 1059 and the low pass filter 1061 can interpolate the output of the correlator 1005.

The processing branch 1065 is essentially similar to the processing branch 1055, wherein correlator 1005 may be the same as the correlator 1005, upsampler 1069 may be the same as the upsampler 1059, and low pass filter 1071 may be the same as the low pass filter 1061. However, since the subband (subband one (1)) processed by the processing branch 1065 has a different frequency offset from the subband (subband two (2)) processed by the processing branch 1055, a mixer 1073 can be used to make a necessary adjustment to the frequency.

The outputs of the processing branches, such as processing branch 1055 and 1065 (and other processing branches in the circuit 1050) can then be provided to a coherent combiner 1075. Output of the coherent combiner 1075 can then be processed to determine the timing of the first path that exceeds a pres-specified threshold by the first path timing unit 1015, as described in the discussion of FIG. 5.

The implementation of the ranging operation can be varied depending upon available resources and desired complexity. For example, the transmission of the special signal S in one direction (such as, from the source device to the destination device) can be different from the transmission in the other direction (from the destination device to the source device). For example, if the destination device is a low price, low performance device, it may not be effective to implement a coherent combining implementation (as shown in FIG. 10c) of the ranging operation since such an implementation can significantly increase hardware costs. In such a situation, an implementation of the processing algorithm shown in FIG. 8 (algorithm 800) with a single correlator may be a cost effective solution. However, the source device, which can be an expensive controller, can implement the circuit 1000 using coherent combining and multiple correlators. A table below can show possible implementations of the ranging operation at the source and destination devices.

| Source Device | Destination Device |
|---|---|
| Algorithm 700 (FIG. 7) | Algorithm 700 |
| Algorithm 700 | Algorithm 800 (FIG. 8) |
| Algorithm 700 | Algorithm 900 (FIG. 9) |
| Algorithm 800 | Algorithm 700 |
| Algorithm 800 | Algorithm 800 |
| Algorithm 800 | Algorithm 900 |
| Algorithm 900 | Algorithm 700 |
| Algorithm 900 | Algorithm 800 |
| Algorithm 900 | Algorithm 900 |

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method for determining a separation between a first device and a second device, the method comprising:
transmitting a first signal on a first plurality of subbands to the second device, wherein the first signal is known at the second device;
receiving a second signal from the second device, wherein a second plurality of subbands is used to transmit the second signal, wherein the second signal is known at the first device;
determining a timing for the second signal; and
calculating the separation based on the timing for the second signal.

2. The method of claim 1, wherein the second signal also contains timing information for the first signal, and wherein the calculating also uses the timing information for the first signal to calculate the separation.

3. The method of claim 1 further comprising:
at the second device,
receiving the first signal;
determining a timing for the first signal; and
transmitting a second signal on the second plurality of subbands to the first device.

4. The method of claim 3, wherein the first determining and the second determining use the same technique to determine the timing for the first signal and the second signal.

5. The method of claim 3, wherein the second transmitting further comprises transmitting a receive time and a transmit time.

6. The method of claim 1, wherein the first determining comprises:
for each subband in the second plurality of subbands, correlating a received signal in the subband;
non-coherently combining results of the correlating for each subband; and
selecting a first path from results of the non-coherent combining which exceeds a pre-specified threshold.

7. The method of claim 6, wherein the result of the correlating for subband K is expressed as: {d₁^{K}, d₂^{K}, . . . , d_{N}^{K}}, and wherein the non-coherent combining can be expressed as:
{\tilde{d}₁, \tilde{d}₂, . . . , \tilde{d}_{N}}={\sqrt{(d₁¹)²+(d₁²)²+(d₁³)²}, \sqrt{(d₂¹)²+(d₂²)²+(d₂³)²}, . . . , \sqrt{(d_{N}¹)²+(d_{N}²)²+(d_{N}³)²}},
where {\tilde{d}₁, \tilde{d}₂, . . . , \tilde{d}_{N}} is the result of the non-coherent combining.

8. The method of claim 6, wherein the selecting comprises determining a timing associated with the first path.

9. The method of claim 1, wherein the first determining comprises:
for each subband in the second plurality of subbands, correlating a received signal in the subband;
selecting a first path from each correlating result which exceeds a pre-specified threshold; and
averaging a time associated with each selected first path.

10. The method of claim 9, wherein the selecting comprises determining a timing associated with the first path.

11. The method of claim 9, wherein the averaging comprises adding up the time for each first path and dividing by a number of first paths.

12. The method of claim 1, wherein the first determining comprises:
for each subband in the second plurality of subbands,
correlating a received signal in the subband;
interpolating the correlating result;
coherently combining the interpolating results; and
selecting a first path from results of the coherent combining which exceeds a pre-specified threshold.

13. The method of claim 12, wherein the interpolating comprises:
upsampling the correlating results; and
filtering the upsampled correlating results.

14. The method of claim 1, wherein the second signal also contains timing information for the first signal, and wherein the calculating comprises computing a difference in a time of transmitting the first signal and the timing of the second signal minus any processing time at the second device.

15. The method of claim 14, wherein the difference can be expressed as:
difference=T^{1t}−T^{1r}−(T^{2t}−T^{2r}),
where T^{1t} is a time associated with the transmission of the first signal, T^{1r} is the timing of the first signal, T^{2t} is a time associated with the transmission of the second signal, and T^{2r} is the timing of the second signal.

16. The method of claim 1, wherein the first signal and the second signal are identical.

17. The method of claim 1, wherein each subband in the first plurality of subbands and the second plurality of subbands carries a different signal.

18. The method of claim 1, wherein the determining comprises obtaining a channel estimation of a communications channel used to transmit the second signal and wherein the channel estimation is obtained using a correlator, a least-squares estimator, or a training-based adaptive channel identifier.

19. A circuit comprising:
a plurality of correlating branches coupled to a signal input, each correlating branch is configured to correlate a received signal with a hypothesis, wherein the received signal provided to a processing branch is from a subband in a transmitted signal, wherein each subband carries a known signal; and
a combiner coupled to the plurality of correlating branches, the combiner is configured to combine the outputs from the plurality of correlating branches.

20. The circuit of claim 19, wherein each subband carries an identical signal.

21. The circuit of claim 19, wherein the combiner performs non-coherent combining.

22. The circuit of claim 21 further comprising a first path timing unit coupled to the combiner, the first path timing unit is configured to derived timing information of an initial path to exceed a threshold.

23. The circuit of claim 19 further comprising a first path timing unit coupled to the plurality of correlating branches, the first path timing unit is configured to derived timing information of an initial path from each correlating branch to exceed a threshold.

24. The circuit of claim 23, wherein the combiner averages the timing information from the initial path from each correlating branch.

25. The circuit of claim 19, wherein a processing branch comprises:
a correlator coupled to the signal input, the correlator is configured to correlate the received signal with a hypothesis;
an interpolator coupled to the correlator, the interpolator comprising,
an upsampler configured to upsample an output of the correlator by a given factor; and
a filter coupled to the upsampler, the filter configured to remove images of the upsampled correlator output
